(19) United States
(12) Patent Application Publication
(10) Pub. No.: US 2015/0180857 A1
(43) Pub. Date: Jun. 25, 2015

(54) Simple user management service utilizing an access token

(71) Applicants: Joseph Schulman, Seattle, WA (US); Hermann Calabria, Seattle, WA (US)

(72) Inventors: Joseph Schulman, Seattle, WA (US); Hermann Calabria, Seattle, WA (US)

(21) Appl. No.: 14/139,460

(22) Filed: Dec. 23, 2013

(51) Int. Cl. H04L 29/06

(52) U.S. Cl. CPC H04L 63/0807

(57) ABSTRACT

A system including a user management service server connected to a computer network that authenticates users on behalf of an app server delivering a website or app to a user operating a user client. The system further enables the easy integration of third-party services that utilize managed user data, such as: e-commerce, advertising, payments, content management, and any kind of service that includes user-generated content.

### FIELD OF THE INVENTION

The present invention is related to providing a service to manage users in websites or apps, and more particularly, to ensure said providing is done in a simple, secure, and spam-free manner. Furthermore, the present invention also enables the easy integration of third-party services that utilize managed user data, such as: e-commerce, advertising, payments, content management, and any kind of service that includes user-generated content.

### BACKGROUND

### Prior Art

User authentication directly between a user client and an app server, without any other server or third-party service to assist with the process, is well-known in the field. In FIG. 2 (prior art), user client 7 communicates directly with app server 8 to complete the process of signing in or registering a user. In step 2 of FIG. 2, the user requests a registration or signin form. The app server responds in step 3, with an actual form, usually in HTML form. The user completes the form with the requested information (usually including a password), and submits the requested information in step 4. The app server authenticates the user, and responds in step 5, and typically also sets cookies within the user client to indicate the new state of being signed in. Of course, FIG. 2 shows the case of a successful authentication; in the case of failure, step 5 would comprise of a failure message, no cookie or other state would be set within the user client, and subsequent request/response interactions with the app server would be in the “signed out” state.

The architecture shown in FIG. 2 is widely used across the internet, and can therefore be deemed successful. Much of the success can be attributed to its sheer simplicity.

Unfortunately, spammer attacks have made it increasingly difficult to use the architecture set forth in FIG. 2 without unwanted consequences. For example, spammers have created sophisticated automated tools that are capable of creating millions of fake registrations across many app servers. The fake registrations are subsequently used to post spam and other fraudulent content on app servers. Such postings are also usually automated, which makes it very difficult for any human editors on the app servers to manually weed out spam content from legitimate content. To combat this problem, FIG. 3 (prior art) sets forth the addition of a spam rating service 10 to the previously explained architecture in FIG. 2. In FIG. 3, the app server takes a user-submitted registration form in step 4, sends it to the spam rating service 10 in step 5 to request a spam rating. The spam rating service 10 responds to the request in step 6 with a spam rating, and based on the rating, the app server makes a determination as to whether to accept or deny the user registration. The spam rating service 10 through a variety of methods; one such method is to compare the IP address of the user-submitted registration form to a list of known spam IP addresses. The foregoing list requires frequent updating to add new known sources of spam, and to remove previous sources of spam that are no longer creating spam. The Invision Power Spam Monitor (http://www.invisionpower.com/services/spam-monitor) is hereby incorporated by reference as an exemplary spam rating service, intended to be used exclusively with the Invision Power Community Suite of products.

The architecture shown in FIG. 3 is provided by Invision Power as a bundled service. Unfortunately, an independent developer such as one that is not using the Invision Power Community Suite does not have access to the Invision Power Spam Monitor. Other similar spam monitors exist, but like the Invision Power Spam Monitor, they tend to be specific to one website or app provider. As a result, many independent website or apps do not use a spam monitor, and instead rely on other less-effective countermeasures such as CAPTCHAs that are relatively easy for spammers to defeat (and are increasingly difficult for legitimate users to solve). Therefore, a need exists for a simple service that can be used by any website or app to effectively block spam registrations.

Another shortcoming of the architecture shown in FIG. 2 (prior art) is the increasing need and desire to delegate user authentication and management to a trusted third party. For example, Facebook provides a service called “Facebook Connect” that enables users to connect to an app server by using the user's Facebook credentials. The service uses the authentication standard OAuth (http://tools.ietf.org/html/rfc6749), incorporated herein by reference. Turning to FIG. 4 (prior art), the user client 12 makes a plurality of pre-registration/signin requests in step 1, the user client 12 requests a signin using credentials held within OAuth server 13 to the app server 14 in step 2, and the app server 14 responds to user client 12 with a redirect operation in step 3. In step 4, the user client 12 requests an OAuth server signin page, and in step 5, the OAuth Server 13 responds with the signin page. After the user submits credentials in step 6, the OAuth Server 13 checks whether user's credentials are valid; assuming that they are indeed valid, the OAuth server 13 creates an access token associated to the user and responds to the user client 12 in step 7 with an implied redirect back to the app server and the access token. The user client 12 sends the access token in step 8 to the app server 14, and in step 9 and 10, the app server then confirms the validity of the access token by sending it to OAuth server 13. Assuming that the access token is confirmed to be valid by OAuth server 13, in step 11, the app server responds to the User Client 12 by setting a user cookie or by otherwise associating a previously-created session cookie with the user. Subsequent requests and responses (step 12) are processed by the app server as being associated with the user.

Although the architecture set forth in FIG. 4 (prior art) and described by the OAuth specification does work, it is fairly difficult for a developer to understand and implement. In particular, since the required manipulation of the access token received from the OAuth server in step 7 is not a standard feature of a typical user client 12, client-side scripting (such as JavaScript) is usually required for successful implementation. Likewise, the manipulation of the access token required by the app server 14 is fairly complex. Software Development Kits (“SDKs”) exist in various programming languages to make the task easier, but it can still be a difficult endeavor for a novice developer to implement and understand (unlike the simple architecture presented in FIG. 2). Furthermore, the security research community has raised a number of concerns regarding OAuth 2.0, including concern that the required complexity of implementing OAuth increases the likelihood of implementation errors that could potentially compromise the security of the app server 14 (http://hueniverse.com/2012/07/oauth-2-0-and-the-road-to-hell/, incorporated by reference herein). In light of all the foregoing, a need exists for a simple service and architecture that allows the developer of an exemplary app server 14 to easily delegate user authentication and management to a trusted third party.

### SUMMARY OF THE INVENTION

A system is presented that provides simple and secure user management for websites and applications. While being secure, the system is simple, meaning it can be implemented by developers with minimal difficulty. The system can be used for any type of website or application, including electronic commerce, free or paid content delivery, games, social networks, and services. Furthermore, the system can be used for traditional websites delivered to desktop computers, for mobile websites, and for any kind of native software application including mobile apps.

The system enables simple provisioning of security by leveraging the domain name system. The system can also provision security using cookies. Furthermore, the system enables simple and secure delegation of services involving user information to third-party providers. Examples of such services that can be provided securely by third-parties as enabled by the system include: an e-commerce service, an advertising service, a payment service, a content management service (“CMS”) including user-submitted comments, and a forum service including user-generated content.

### BRIEF DESCRIPTION OF THE DRAWINGS

FIG. 1. is a diagram of the overall system in context of a global computer network

FIG. 2. is a diagram of the prior art, showing an exemplary single user client and an exemplary single app server. The single app server performs all the authentication functionality, without the use of a backend-as-a-service (“BaaS”) server.

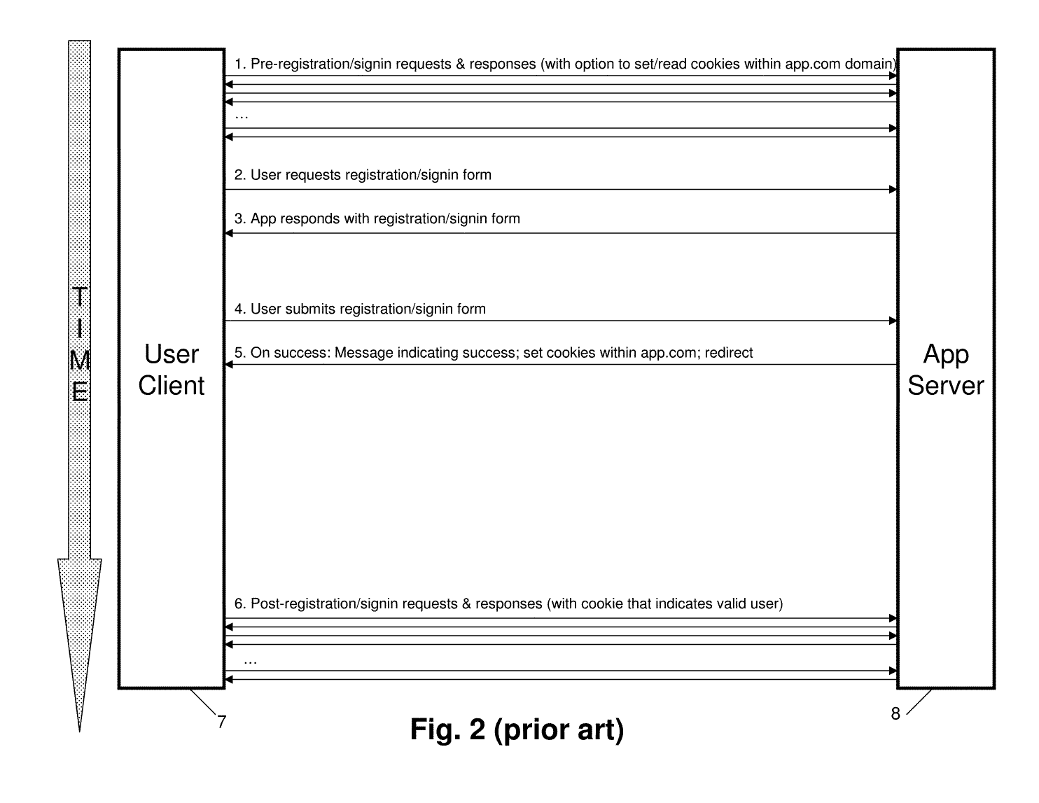

FIG. 3. is a diagram of the prior art, showing an exemplary single user client, an exemplary single app server, and an exemplary spam rating service, configured to check for spam user registrations. The spam rating service provides the app server with a spam rating given an exemplary user registration information.

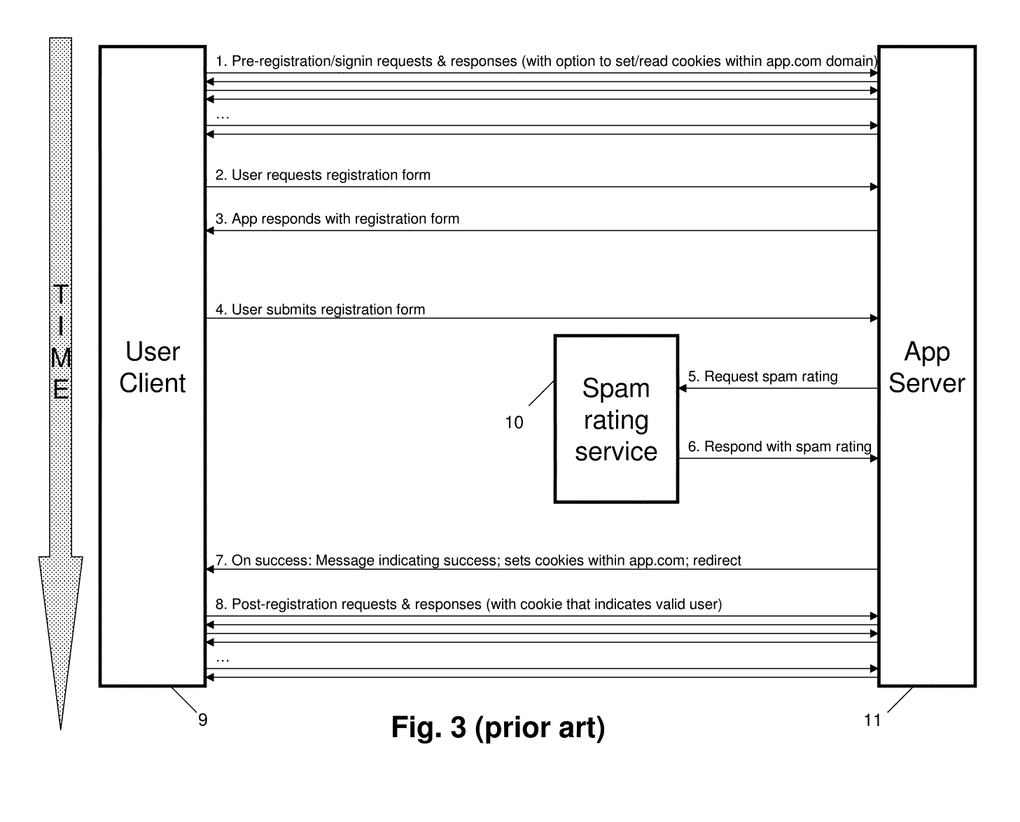

FIG. 4. is a diagram of the prior art, showing an exemplary single user client, an exemplary single app server, and an exemplary OAuth server. The Oauth server is an exemplary BaaS server providing the app server with user authentication services and possibly additional services relating to users associated with the user client.

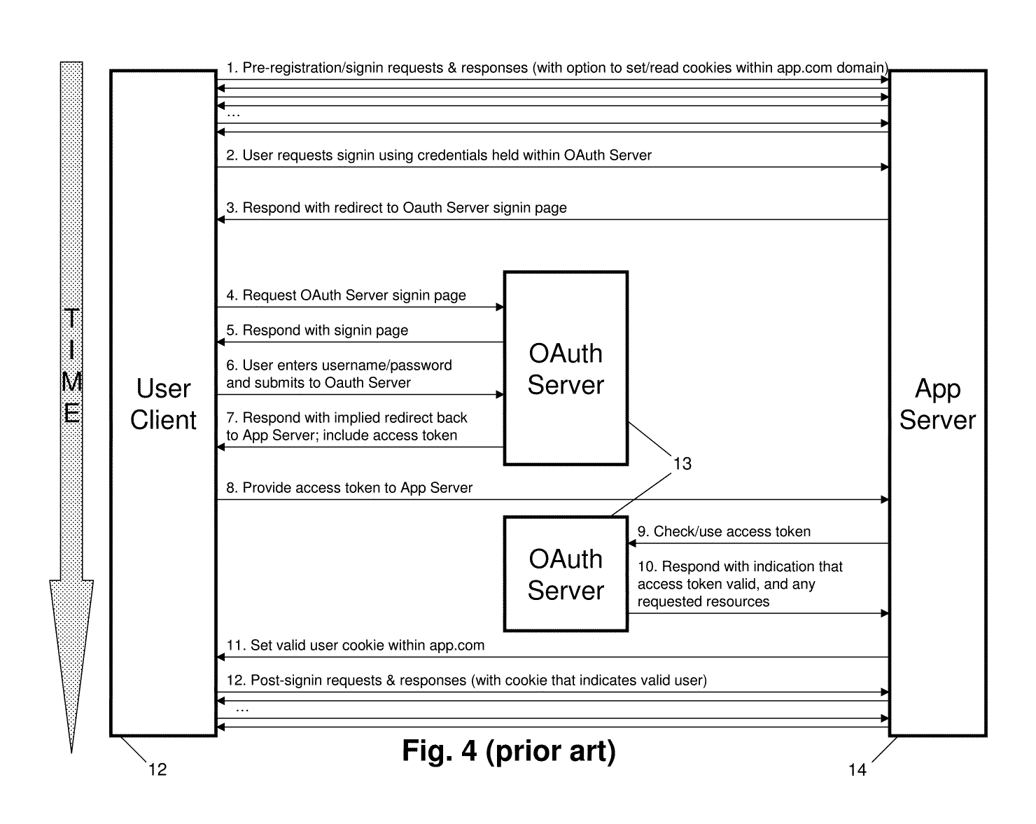

FIG. 5. is a diagram of an exemplary user client, an exemplary BaaS server, an exemplary app server, and an exemplary DNS configuration applied to an exemplary domain name, which enables both the BaaS server to set and read cookies and the app server to read and set cookies within the exemplary domain name.

FIG. 6. is a diagram of an exemplary user client, an exemplary BaaS server, and two exemplary app servers, each having an exemplary domain name. An exemplary DNS configuration is also shown, with exemplary configurations of each of the two domain names for the two exemplary app servers. The exemplary configuration illustrates how a single BaaS server can interoperate with two or more separate app servers (each having a separate domain name).

FIG. 7. is a diagram of a BaaS server configured to act as an exemplary UMS server connected with an exemplary user client and an exemplary app server. The UMS server and the app server are configured for UMS server providing registration and signin forms to the user client. The UMS server and the app server are configured for the app server to request validation of user from the UMS server prior to providing post-registration/signin requests & responses.

FIG. 8. is a variant of the configuration disclosed by FIG. 7. In FIG. 8, the UMS server and the app server are configured for the app server to provide registration and signin forms to the user client.

FIG. 9. is a flowchart of the steps utilized by an exemplary UMS server to process a registration request.

FIG. 10. is a flowchart of the steps utilized by an exemplary UMS server to process a sign-in request.

FIG. 11. is a diagram of a BaaS server configured to act as an exemplary UMS server connected with an exemplary user client and an exemplary app server. The UMS server is configured to submit the user/signin registration forms to/from the app server on behalf of the user client.

FIG. 12. is a variant of the configuration disclosed by FIG. 11. In FIG. 12, the UMS server and the app server are configured for the app server to provide registration and signin forms to the user client.

FIG. 13. is a diagram of a BaaS server configured to act as an exemplary UMS server, along with a generic BaaS server. The generic BaaS Server can be configured to provide any number of services as described herein.

FIG. 14. is a diagram of exemplary steps utilized by a generic BaaS server, a UMS server, an app server, and a user client.

FIG. 15. is an exemplary table of secret keys and apps.

FIG. 16. is a diagram illustrating an exemplary BaaS server configured as an advertising server, working in conjunction with a UMS server, a first app server, a second app server, and a first user client.

FIG. 17. is a diagram of an exemplary global network that employs embodiments of the present invention

FIG. 18. is a diagram of an exemplary computer that enacts and enables the embodiments of the present invention

### DETAILED DESCRIPTION OF THE INVENTION

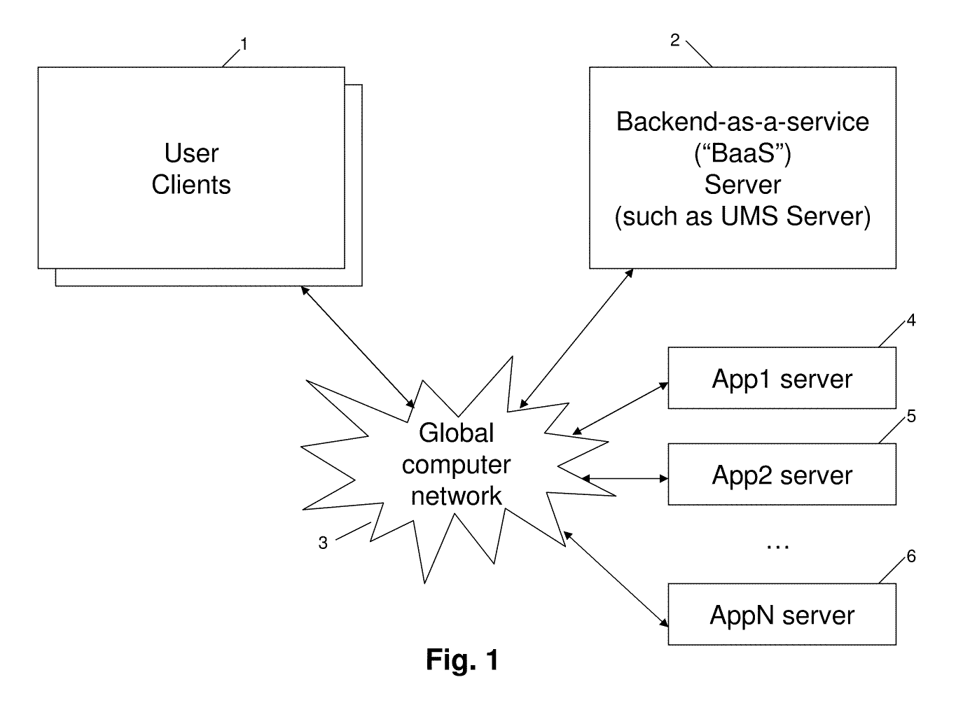

FIG. 1 discloses a backend-as-a-service (“Baas”) server 2, such as a user management service (“UMS”) service, a plurality of user clients 1, and a plurality of app servers 4, 5, 6, all interconnected through a global computer network 3.

A number of embodiments exist for the present invention. They are described below. The following terminology is used in the context of the subject matter described herein.

An entity is a natural person or corporation or partnership other similar legal construct that provides a website or app for users to connect to and use. Such providing can be for-profit or not-for-profit. An entity is usually responsible for the implementation, configuration, and ongoing maintenance of a website or app and its associated components (including one or more app servers).

A user is a natural person connecting to a website or app through a user client. Alternatively, a user may be an agent of the natural person, such as an automated script that performs actions on behalf of the natural person.

A user client is a computing device connected to a global computer network running a software program that allows a user to interact with an app server that is also connected to the global computer network. Examples of user clients include: A laptop computer equipped with the Microsoft Windows operating system and running the Internet Explorer web browser, a touchscreen device such as the Apple iPhone or iPad running the Safari web browser or a software program such as Pandora radio, Bank of America banking application, Facebook social network application, or the CNN news viewer application.

A website or app is a service delivered to a user by an entity. A website or app is usually implemented as a collection of software programs running on one or more app servers.

An app server is a computing device connected to a global computer network running a plurality of software programs that responds to requests from a user client, and in so doing implements a website or app.

A backend-as-a-service (“BaaS”) server is a computing device connected to a global computer network. A BaaS server has the capability to be operated by a first entity, and provided as an arms-length service to a second entity and a third entity without necessarily allowing the second entity to access the data of the third entity. A BaaS server can provide a variety of services, including (but not limited to): a user management service (“UMS”) server, a search service, an RSS service, a payment service, a content management service (“CMS”), an analytics service, a compliance service, a notifications service, an email service, an email marketing service, an A/B testing service, a forum service, a customer-service ticketing service, an advertising service, an affiliate marketing service, a shopping-cart service, an e-commerce service, an operations/status monitoring service, a collaborative filtering service, a recommender service, a queuing service, a robots service, a comments service, and an accessibility service.

A user management service (“UMS”) server is a BaaS server configured to provide user authentication and identity services. An exemplary UMS server is described in detail herein.

A cookie is a small payload of data, associated with a domain name, that can be written to or read from a user client by an app server. A cookie can be used to track the state of a given user client with respect to an app server. In at least one of the embodiments presented herein, cookies can also be written to or read from a user client by a BaaS server, and the cookies are used as a conduit of information between the BaaS server and an app server.

A domain name is a string of characters that uniquely identify a resource or set of resources in a global network. In the present invention, a domain name is used to direct a user client to one or more app servers and one or more BaaS servers that deliver a website or app to a user. The configuration of the domain name is usually exclusively controlled by the entity that delivers the website or app.

A domain name system (“DNS”) is a distributed network of computing devices connected to a global computer network, that translate domain names into IP addresses that are subsequently used to locate and access computing devices such as app servers and BaaS servers. A DNS name server is a server that stores the DNS records for a domain name, such as address (A or AAAA) records, name server (NS) records, mail exchanger (MX) records, canonical name (CNAME) records, and other types of DNS records. A DNS name server responds with answers to queries against its database, much as a phone book can be used to convert a name into a telephone number.

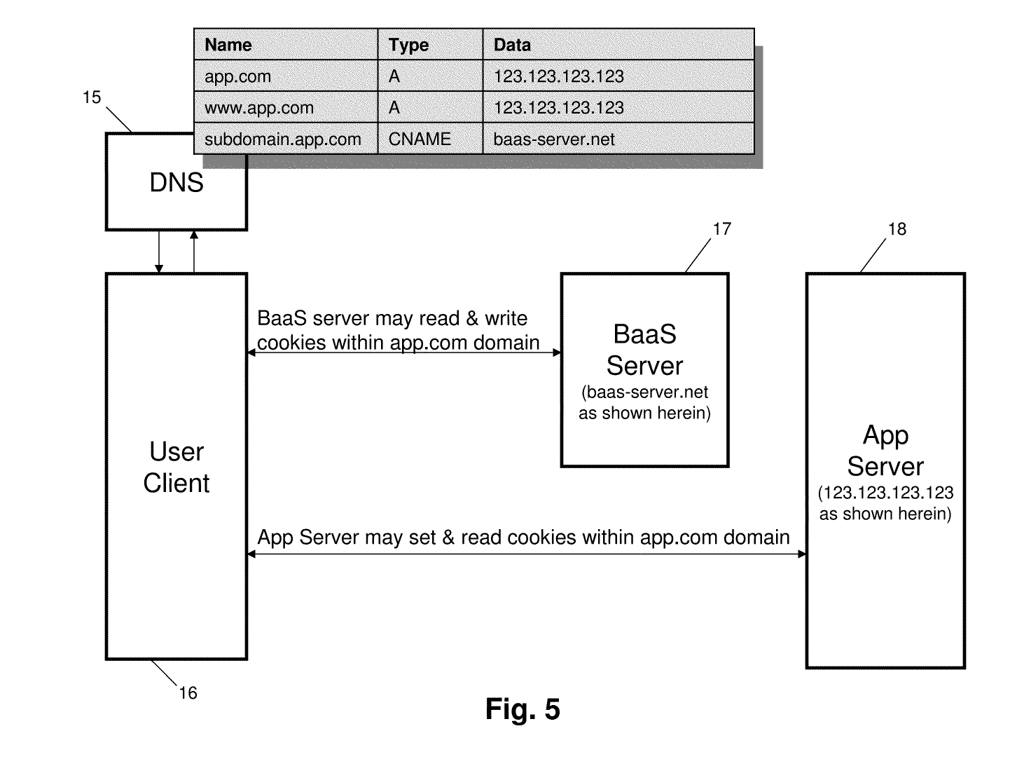

FIG. 5 describes an exemplary configuration that enables a BaaS server 17 to access a set of cookies in a user client 16 relating to and accessible by an app server 18. The entity that operates the app server 18 usually also controls a domain name associated with the app server. So, for example, if the app server provides a service called “app”, an exemplary domain name may be “app.com”. Control of the domain name is exercised by controlling the DNS record that is authoritative for the domain name. In FIG. 5, an exemplary DNS 15 is disclosed, along with an exemplary configuration such that an access by the user client to app.com or www.app.com directs the user client to 123.123.123.123, and an access by the user client to subdomain.app.com directs the user client to baas-server.net, the latter itself being a domain name (and perhaps controlled by a different entity) and ultimately directing the user client to the BaaS server 17.

When the user client 16 accesses the BaaS server 17 or app server 18 through an app.com domain name, either server has the capability to read and write cookies to/from the user client, the cookies associated with the app.com domain name. Therefore, the configuration provides a convenient conduit for the app server and the BaaS server to exchange information, including access tokens. Furthermore, since the entity that controls the exemplary app.com domain name is able to exercise control over the DNS that is authoritative over the domain name, then the entity is also explicitly extended the ability to control the existence or absence of the conduit between the app server and the BaaS server to exchange information. For example, if the entity that controls app.com decides to grant or revoke the BaaS server's ability to read and write cookies containing access tokens, then the entity also controls the BaaS server's ability to act as a user management service or provide any other related services to the app server. Therefore, by using cookies to communicate state between the BaaS server and the app server, the app server developer avoids the difficulty and challenges associated with OAuth or other prior art. Instead, the developer may rely upon the cookie mechanism widely available in user clients to pass information accurately and timely between the UMS server and the app server.

It will be understood that there are a number of alternative DNS configurations available with equivalent results. For example, rather than using a CNAME record to direct subdomain.app.com to the BaaS server by referencing its own domain name (baas-server.net in the example shown in FIG. 5), it is also possible to use an A record to direct subdomain.app.com to the BaaS server by referencing its IP address. When the app server does not have a secured-socket layer (SSL) configuration, the configuration shown in FIG. 5 is the preferred embodiment because it allows the entity controlling the BaaS server and the baas-server.net domain name the ability to change the IP address of the BaaS server without having to contact the entity that controls the app.com domain name. Alternatively, if the app server does employ an SSL configuration, it is possible that the CNAME method will not work on some older configurations. If this is the case, the alternative configuration using the A record and the IP address of the BaaS server will work.

It will also be understood that the present disclosure may be expanded beyond cookies because it is designed for any set of identifiers or configuration that are set using hierarchical namespaces such as domains, class names in code, and configuration that may be shared among related apps on a mobile device, where a BaaS server is granted the right to operate in a namespace by an entity that controls the namespace. Therefore, by using a common mechanism, all groups in the entity may take advantage of the third-party service without having use a mechanism specific to the BaaS server to read the configuration.

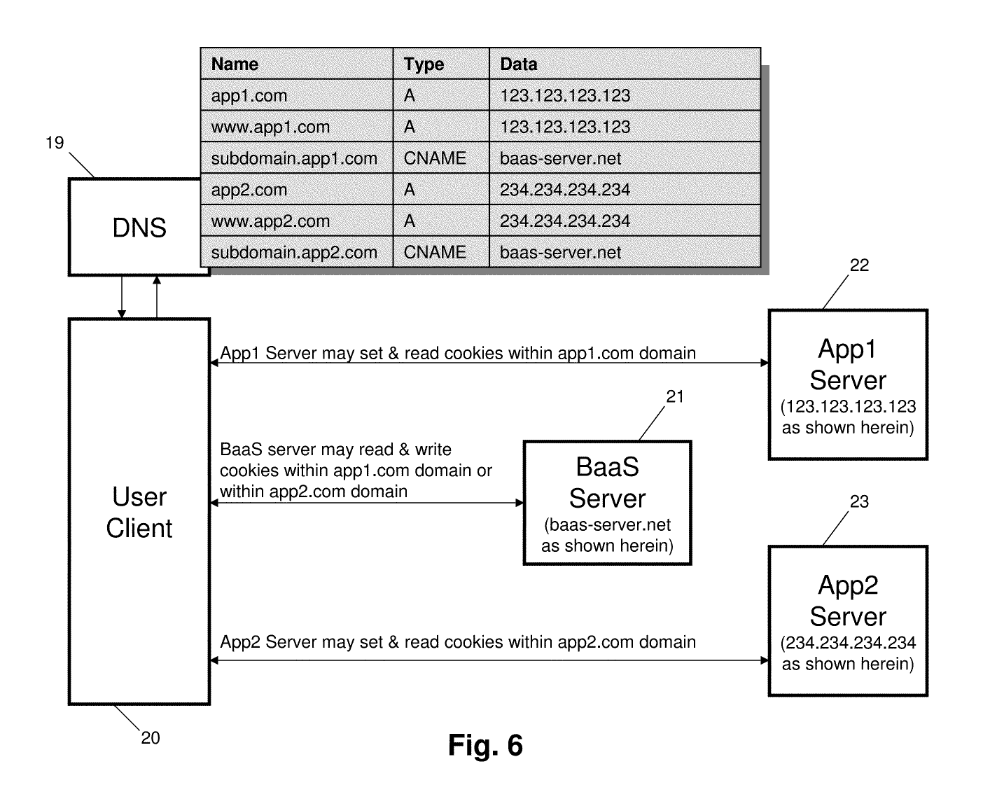

The present embodiment enables the BaaS server 17 to act separately on behalf of two or more separate entities, each controlling its own app server and its own domain name. For example, in FIG. 6, an exemplary DNS 19 is disclosed that is configured for an app1.com domain and an app2.com domain. Although disclosed on the same table, the A and CNAME records for each of app1.com and app2.com are controlled separately, each by its own respective entity. Likewise, each of the entities also controls and operates each of app1 server 22 and app2 server 23. The BaaS server is operated by another entity, and provides a service to app1 and app2 separately. When a user operating a user client 20 accesses app1, the app1 server responds to the user client by redirecting the user to the BaaS server. Such redirecting can be through automated, such as utilizing an http redirect, or may require a user action, such as an <A> HTML tag displaying a link to the user and requiring the user to click on the link, and the redirecting occurring through subdomain.app1.com in the example shown. Upon redirecting to the BaaS server, the BaaS server can serve pages and perform other functions, and furthermore because the BaaS server is accessed through the exemplary subdomain.app1.com domain, it is also able to read and write cookies to the user client within the app1.com domain. The same mechanism occurs for the app2 server, involving the app2.com domain, but the same BaaS server.

Care must be taken when using the configuration set forth in FIGS. 5 and 6 to avoid cross-site request forgery (“CSRF”) attacks and cross-site scripting (XSS) attacks. CSRF attacks are described fully in the Wikipedia article “Cross-site request forgery” (http://en.wikipedia.org/wiki/Cross-site_request_forgery), which is hereby incorporated by reference. XSS attacks are described fully in the Wikipedia article “Cross-site scripting” (http://en.wikipedia.org/wiki/Cross-site_scripting) which is hereby incorporated by reference.

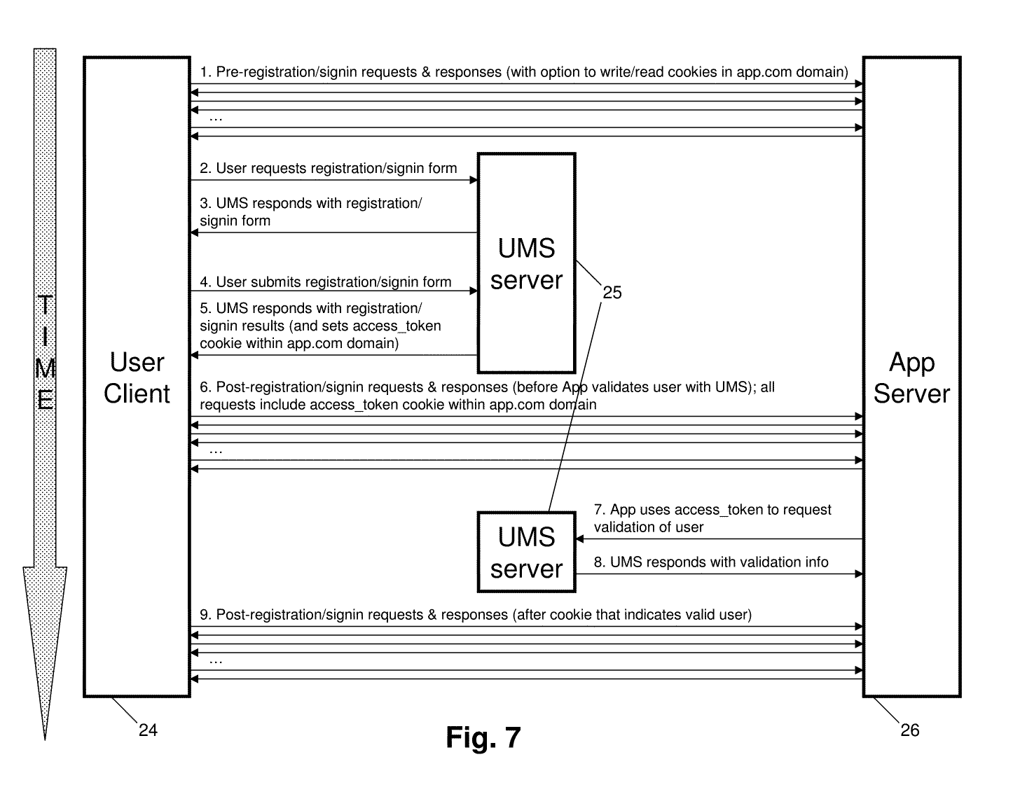

FIG. 7 describes an exemplary BaaS server configured as a UMS server 25 to provide user authentication and identity services to an app server 26.

In step 1, a user client 24 and the app server exchange requests and responses in which the state of the user client is not signed in. During the requests and responses, the app server has the option to write and read cookies to and from the user client within an app.com domain related to the app server. One reason for the app server to write and read the cookies is to track the session of the user client, even before a user has formally signed in to the app server. Many server environments, such as the well-known Linux+Apache+PHP stack, perform this function automatically.

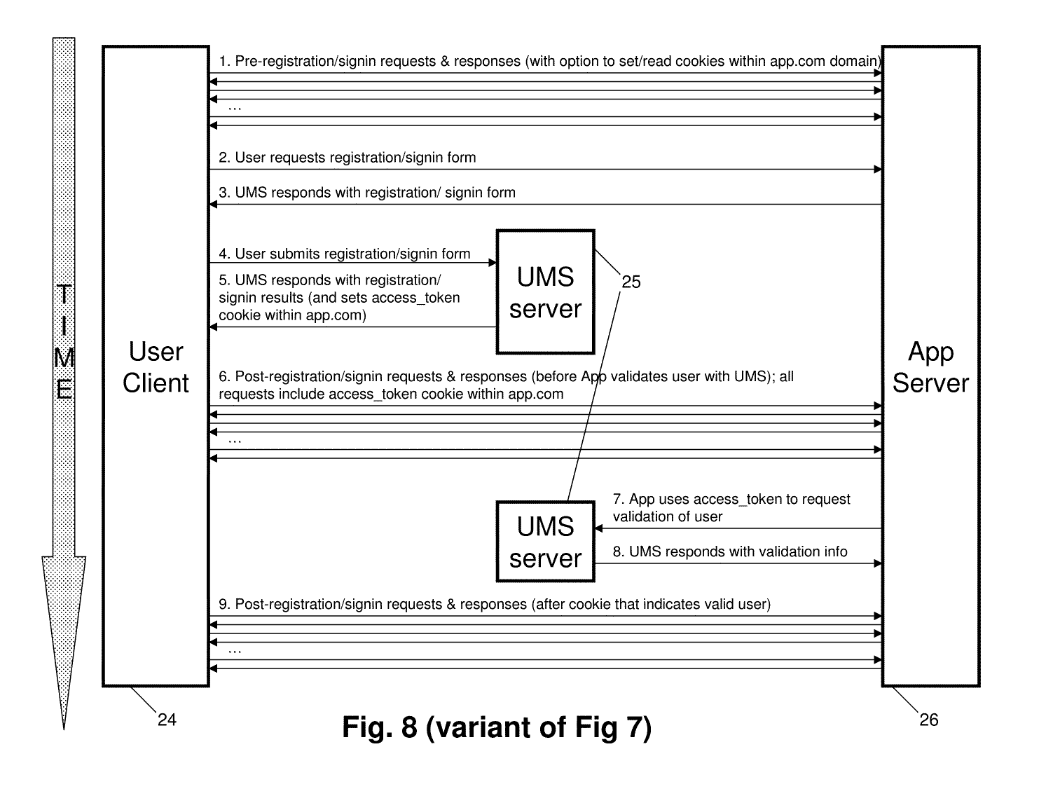

In step 2, a user desires to formally sign into the app server, and requests a registration or signin form. Depending on the configuration desired by the entity that controls the app server, there are a number of variants available to complete steps 2 and 3. The first variant is illustrated in FIG. 7, wherein the user request is made to the UMS server in step 2, and the UMS server responds with a secure form in step 3. The first variant is preferred from a security perspective, because the UMS server is fully delegated with the delicate process of collecting the user's credential information, including the user's password. A second variant is illustrated in FIG. 8, wherein the user request is made to the app server in step 2, and the app server responds with a form in step 3. The second variant can be as secure as the first variant, but some of the burden of security shifts to the entity that operates the app server. A third variant (not illustrated, but described herein) is that the user client presents a user registration or signin form without making a request to the app server or the UMS server. The third variant can be implemented using a scripting language such as Javascript, wherein when the user clicks on a link or other element indicating that s/he wishes to sign in or register, an exemplary modal dialog is presented to the user, requesting credentials such as an email address and password. In a fourth variant of FIG. 7, the UMS server redirects the request in step 2 to itself, but via a different, secured domain name, before responding to the user in step 3. For example, http://subdomain.app.com/login is redirected to https://baas-server.net, between steps 2 and 3. The advantage of this variation is that the UMS server is able to provide an SSL-protected registration/signin form to the user client, without the app server having to purchase, install, and maintain an SSL certificate. There are a number of other alternative and well-known methods of presenting a registration or sign-in form to a user.

Once the user submits credentials, the credentials are transmitted by the user client to the UMS server in step 4. The UMS server processes the credentials, and makes a determination as to whether to allow or disallow the request to sign-in or register. A number of methods for making the determination are disclosed herein; in step 5, the UMS server responds with the determination/result, and if registration/signin is allowed, creates an access token and writes a cookie with the access token within the app.com domain. Alternatively, an access token cookie may be preemptively written by the UMS server in step 3 (if using the variant illustrated in FIG. 7), and later activated in step 5 once the UMS server determines that the registration/signin is allowed.

In step 6, the user client sends one or more requests & receives responses to and from the app server. However, in each of the requests, an access token cookie is included in the app.com domain, and the cookie is readable by the app server. The access token is transmitted to the UMS server in steps 7 and 8 to validate the user. If the user is validated, subsequent requests & responses (step 9) between the user client and app server

There are a number of methods of creating an access token. One method is to create an access token related to the user, either by using the user's id itself, by encrypting the id, or by creating a combination of a user's id plus a random or pseudo-random value. Another method, the preferred method, is to create a cryptographic nonce, such nonce being a random or pseudo-random value created by the UMS server and indexed to the user's id, and the nonce being presentable once, and only once, to the UMS server to change the state of the user from being “signed out” to being “signed in”. Therefore, if the nonce is presented a second time to the UMS server with the request to change the state of the user from being “signed out” to being “signed in”, such request will be rejected, which can help avoid security issues related with CSRF attacks and replay attacks.

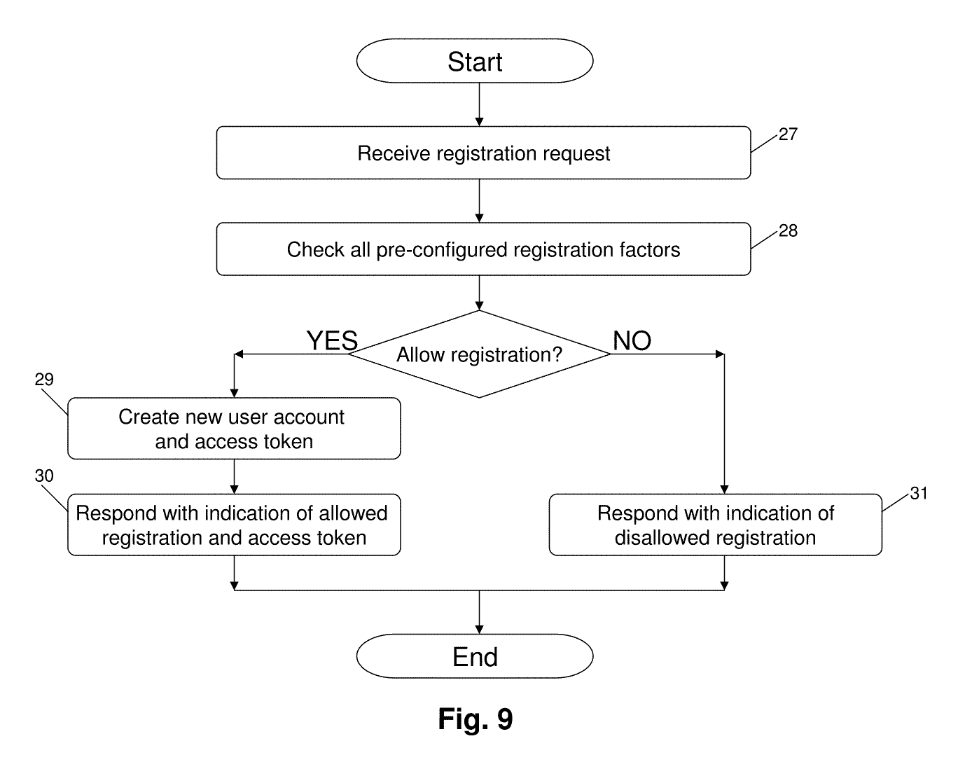

FIG. 9 is a flowchart of a sequence of steps that occurs within a UMS server to determine whether to allow or disallow a user to create a registration for an app server. The sequence begins with step 27, wherein the UMS server receives the registration request. The request can be received in a number of ways; the preferred way is an HTTP “POST” request containing registration parameters provided by the user such as a user name, a user email address, a desired password, an IP address of a user client being utilized by the user, a domain name indicative of the app server, a set of cookies corresponding to the user client and the domain name, and additional parameters that may be desired.

Once the registration request is received, the UMS server must determine whether to allow or to disallow the registration. Step 28 is to check all registration factors that are pre-configured for the app server. Registration factors that may be pre-configured for each individual app server include: requiring that the registration originates from a page delivered by the UMS server and not forged by an unauthorized server, requiring that the registration parameters be submitted over an SSL or otherwise encrypted connection, requiring the correct answer to a CAPTCHA or similar challenge, performing a unique browser identifier check using Panopticlick or a similar technology, checking that the user reads and accepts one or more legal agreements associated with the app server, checking if the user is already registered, checking that the submitted user email address is valid, checking a reputation of the IP address of the user client, checking if the submitted user name is valid or includes unacceptable words such as known trademarks, checking if the app server is allowing registrations at the time that the registration is submitted, flagging a given registration as requiring further approval by the app server, checking for required parameters (such as first name, last name, username, email, birthday, ZIP code, or other desired combinations), checking if the age of the user meets certain criteria, checking if the location of the user meets certain criteria, checking if the user agent is acceptable, checking if the user (based on an IP address, a session ID, or other indicia) has created too many accounts in a given period of time, checking if the email address is capable of receiving emails, checking if the email address resolves to a blacklist of known spammers, and checking if the entity that owns the app server has paid all due fees to the UMS server entity. In an alternative embodiment, the step 28 may include an additional step wherein the checking of registration factors includes sending a request to the app server with the proposed registration, and receiving from the app server a response indicative of whether to allow or disallow the registration.

If the registration is allowed, a user account and access token are created in step 29. The creation of the user account involves adding a new row or record to a user database with the user information, using any number of well-known techniques and databases such as MySQL. In step 30, the UMS server responds to the user client with an indication that the registration is allowed, and with the access token. In the preferred embodiment, the response is a direct response to the HTTP post from step 27, and the response contains an HTTP “set-cookie” header containing the access token, for the user client to store, the storing of the access token associated with the domain name associated with the HTTP post from step 27. In an alternative embodiment, the response also contains cookies from the app server.

If the registration is disallowed, the UMS server responds to the user client in step 31 with an indication that the registration is disallowed. In the preferred embodiment, a reason for disallowing may be included in the response.

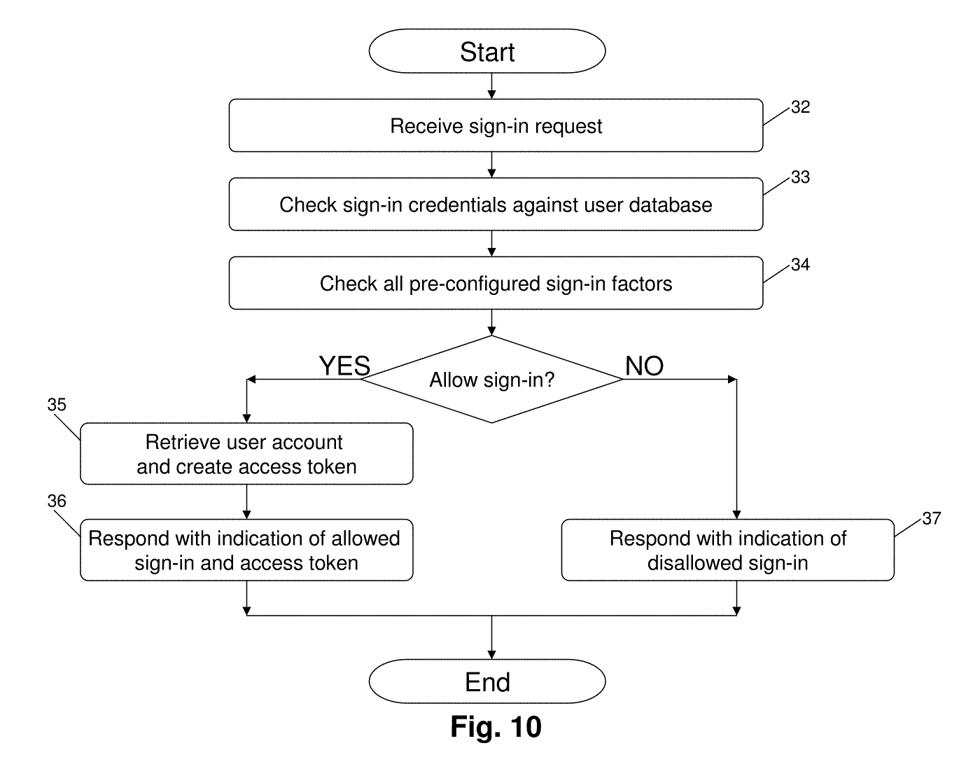

FIG. 10 is a flowchart of a sequence of steps that occurs within a UMS server to determine whether to allow or disallow a user to sign in to an app server. The sequence begins with step 32, wherein the UMS server receives the sign-in request. The request can be received in a number of ways; the preferred way is an HTTP “POST” request containing sign-in credentials provided by the user such as a user name or user email address, and a password. Additional parameters and data may also be provided to the UMS server, including an IP address of a user client being utilized by the user, a domain name indicative of the app server, a set of cookies corresponding to the user client and the domain name, and additional parameters as desired.

Once the sign-in request is received, the UMS server must determine whether to allow or to disallow the sign-in. Step 33 is to check the credentials against a user database. The checking involves retrieving an existing row or record from a user database with the user information and comparing it to the provided credentials; any number of well-known techniques and databases such as MySQL may be used.

There are a number of alternative credentials available for signing in, including: A digital certificate, a username, a one-time password delivered via a non-browser channel such as email, SMS message, first-party app push notification, third-party app push notification, and a friend's account. The preferred embodiment is an email address and a password.

Step 34 is to check the pre-configured sign-in factors. Such factors are used as additional checks beyond the basic credential, are pre-configured for each individual app server, and include: checking a reputation of a user session associated with the user client, checking the IP address associated with the user client, requiring that the sign-in originate from a page delivered by the UMS server and not from a forged server, requiring that the sign-in credentials be provided over an SSL or otherwise encrypted connection, checking a user agent identifier associated with the user client, checking an OS version identifier associated with the user client, checking a browser software vendor and version associated with the user client, checking an accept-language field associated with the user client, checking a screen resolution field associated with the user client, performing a unique browser identifier check using Panopticlick or a similar technology, checking an ETAG associated with a user avatar, checking the results of a CAPTCHA challenge, checking if the app server is accepting logins, checking if an account associated with the user has been disabled or blocked, checking if an account associated with the user is in good billing standing, checking if an account associated with the app server is in good billing standing, checking if a portion of the credentials have been used too many times within a period of time, checking if a user has provided all required information, and checking that the user reads and accepts one or more legal agreements associated with the app server. In an alternative embodiment, the step 34 may include an additional step wherein the checking of sign-in factors includes sending a request to the app server with the proposed sign-in, and receiving from the app server a response indicative of whether to allow or disallow the sign-in.

In an alternative embodiment, steps 34 and 33 may be performed in reverse sequence. In another alternative embodiment, step 34 may be skipped if step 33 indicates a disallowed sign-in. In another alternative embodiment, step 33 may be skipped if step 34 indicates a disallowed sign-in.

If the sign-in is allowed, a user account is retrieved and an access token is created in step 35. In step 36, the UMS server responds to the user client with an indication that the sign-in is allowed, and with the access token. In the preferred embodiment, the response is a direct response to the HTTP post from step 32, and the response contains an HTTP “set-cookie” header containing the access token, for the user client to store, the storing of the access token associated with the domain name associated with the HTTP post from step 32. In an alternative embodiment, the response also contains cookies from the app server.

If the sign-in is disallowed, the UMS server responds to the user client in step 37 with an indication that the sign-in is disallowed. In the preferred embodiment, a reason for disallowing may be included in the response.

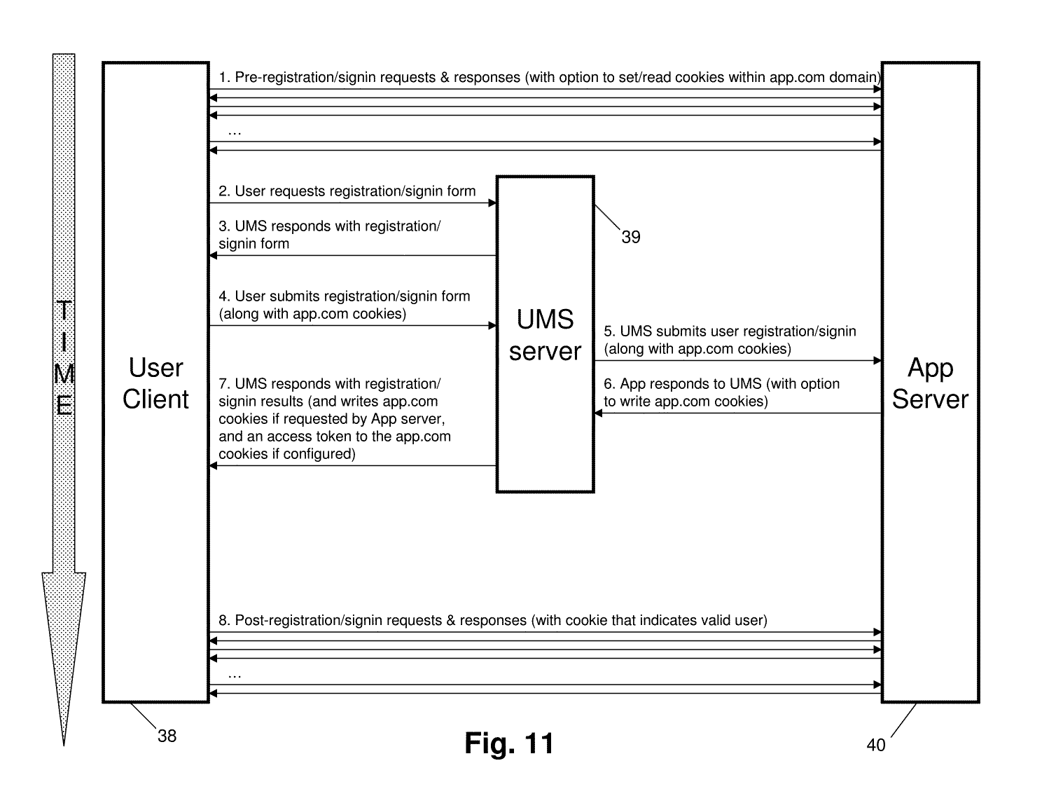

FIG. 11 describes an alternative embodiment of the present invention, wherein an exemplary BaaS server is configured as a UMS server 39 to provide user authentication and identity services to an app server 40.

In step 1, a user client 38 and the app server exchange requests and responses in which the state of the user client is not signed in. During the requests and responses, the app server has the option to write and read cookies to and from the user client within an app.com domain related to the app server. The foregoing is analogous to the step 1 disclosed for FIG. 7.

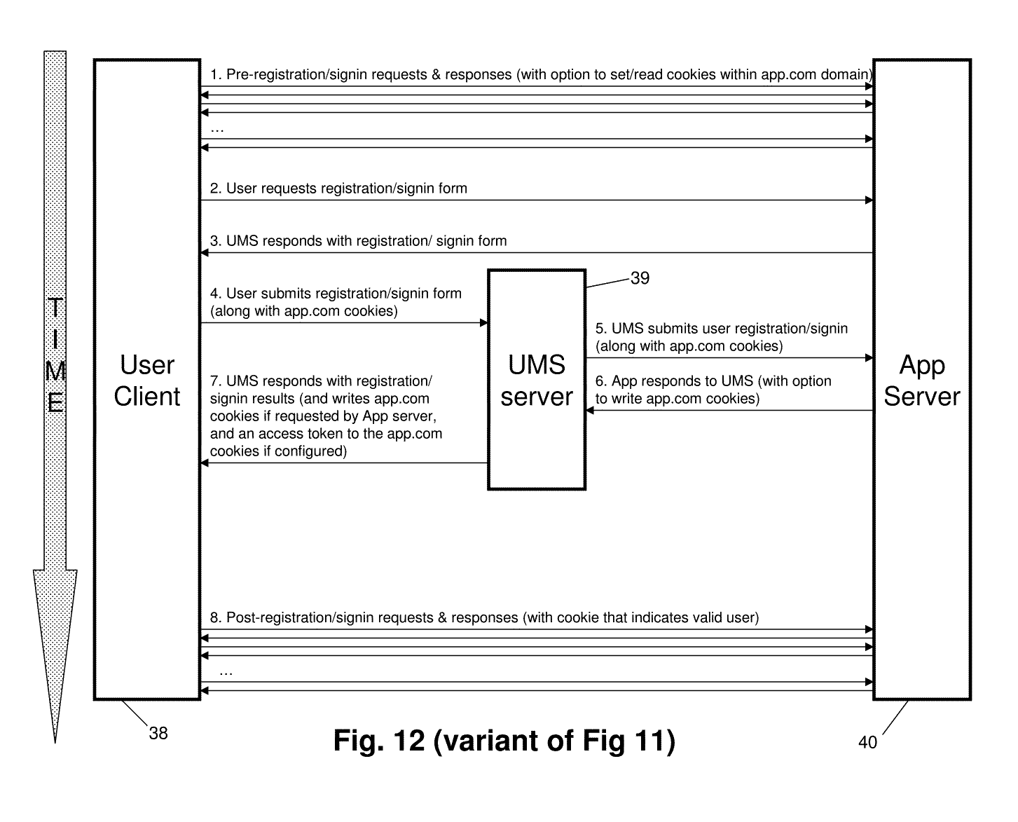

In step 2, a user desires to formally sign into the app server, and requests a registration or signin form. Depending on the configuration desired by the entity that controls the app server, there are a number of variants available to complete steps 2 and 3. The foregoing is analogous to the step 2 disclosed for FIG. 7, including the variants. The second variant previously discussed, wherein the registration/signin form is presented by the app server, is disclosed in FIG. 12.

Once the user submits credentials, the credentials are transmitted by the user client to the UMS server in step 4. The UMS server processes the credentials, and makes a determination as to whether to allow or disallow the request to sign-in or register. A number of methods for making the determination are disclosed herein

If the UMS server disallows sign-in or registration, the UMS server goes to step 7 (skipping steps 5 and 6) and responds to the user client with an indication that the registration or sign-in is disallowed.

If the UMS server conditionally allows sign-in or registration, the UMS server executes step 5 by submitting the proposed sign-in or registration to the app server 40. In addition to submitting the proposed sign-in or registration to the app server, the UMS server may also submit the app.com cookies it received in step 4. By doing so, the UMS server is impersonating the user client 38, so in addition, it may also mimic other aspects of the request from step 4 from the user client. The foregoing impersonating is convenient because many existing web technologies include rudimentary protection against fraudulent requests; therefore, by mimicking the user client, the UMS server enables the app server to continue to use the rudimentary protection without modification.

Step 5 occurs as a request to the app server from the UMS server. The app server must be protected from fraudulent servers posing as the UMS server attempting to fraudulently create or sign-in users. There are many ways to protect the app server, some of which can be used in combination, including: Requiring the use of SSL or other forms of encryption on the registration or sign-in data, requiring the use of a secret shared key between the UMS server and the app server, requiring the request from the UMS server to be submitted through a secret URL on the app server, and requiring the use of the OpenSSL security protocol.

Once the request from step 5 is successfully received by the app server, the app server makes its own determination as to whether to allow or disallow the proposed sign-in or registration. One determination that most app servers will have in common is whether a data processing error occurred; if so, the registration or sign-in will be denied. Other reasons for the own determination as used by the app server are many and varied, and depend on the website or app and its associated entity.

In step 6, the app server responds to the UMS server with an indication as to whether the proposed registration/sign-in is allowed or disallowed. In addition, the app server has the option to instruct the UMS server to write app.com cookies to the user client in the subsequent step 7. Such instructions can be passed as part of the response body, or as part of the response header. If passed in the response header, the HTTP ‘set-cookie’ header may be used.

Once the UMS server receives the response from step 6, the UMS server records the successful registration or sign-in, as disclosed herein, and then responds to the user client in step 7. Note that the response in step 7 is actually a response from step 4, because the user client is kept waiting for a response during the time that the UMS and app servers are executing step 4 (and steps 5 and 6 if the registration/sign-in is conditionally allowed by the UMS server pending full allowance by the app server). Step 7 includes an indication to the user client as to whether the registration was allowed or disallowed, and optionally may also include instructions to write cookies to the user client as previously disclosed, the preferred embodiment being an HTTP ‘set-cookie’ header.

An alternative embodiment includes the UMS server creating an access token and writing a cookie with the access token within the app.com domain as an additional sub-step of step 7. The creating of an access token is the same as described herein for FIG. 7. As described herein, an access token cookie may be preemptively written by the UMS server in step 3 (if using the variant illustrated in FIG. 11), and later activated immediately prior to step 7 once the UMS server determines that the registration/signin is allowed after the response from the app server set forth in step 6.

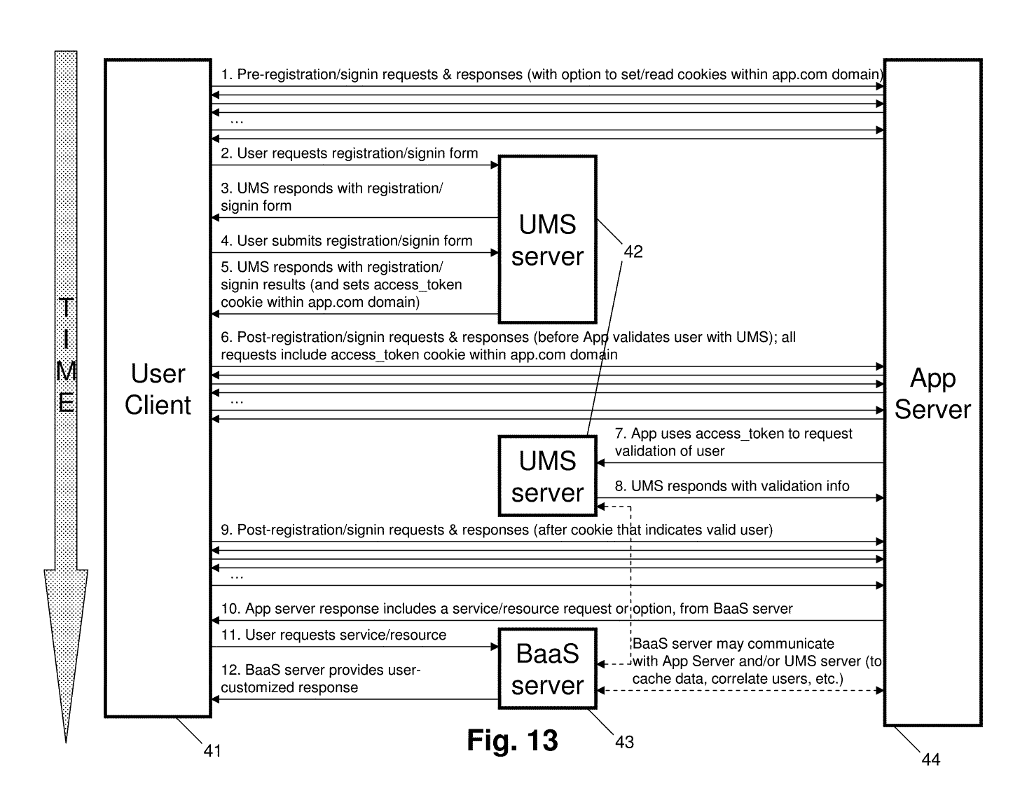

FIG. 13 illustrates an exemplary BaaS server 43 operated in conjunction with a UMS server 42, the UMS server being a BaaS server configured to operate as a UMS server. The domain name used to access the app server 48 is configured to allow the BaaS server 46 and UMS server 47 to read and write cookies as disclosed herein. The BaaS server 43 can be configured to operate as any number of different services, such as an advertising service, a payments service, a content management service, an e-commerce service, a shopping-cart service, and any other number of services as described herein.

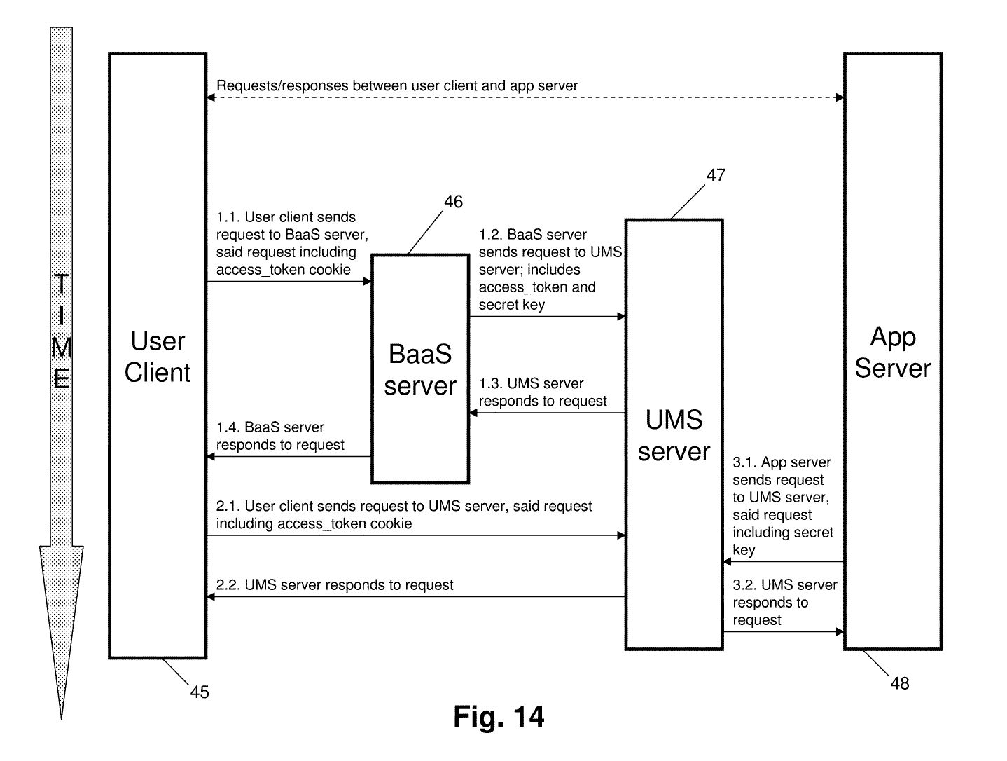

In FIG. 13, a user signs in or registers in steps 1-9 as disclosed in detail in the descriptions pertaining to FIGS. 7-12. Step 10 is an app server response including a service or resource request or option from BaaS server 43. The response can be an automatic http redirect, a static HTML tag such as an <A> tag, a script (such as Javascript) containing a service/resource request, or any other number of similar responses that causes the user client to perform a subsequent step 11 to make a request for a service or resource from the BaaS server 43. Step 11 may include an access token that is readable by the BaaS server. When the request is received by the BaaS server, the BaaS server processes the request and optionally sends a request to the UMS server 42 to consume or produce data related to the user operating the user client 41 as identified by the access token if provided, and/or the app server 44 to cache data, correlate users, or any other operation involving the app server. The optional steps are identified in FIG. 13 by dashed lines, but described in detail herein by FIG. 14. Once the request 11 is fully processed, the BaaS server responds in step 12 with a user-customized response.

FIG. 14 illustrates in detail an exemplary data flow between a user client 45, a BaaS server 46, a UMS server 47, and an app server 48. For brevity, in FIG. 14 it is assumed that a user has already signed in or registered with the UMS server, and that the access token cookie described herein is in place in the user client. FIG. 14 also shows, in dashed lines, the customary flow of requests & responses between user client and app server. Three of many different possible embodiments are shown; the first begins with step 1.1, the second begins with step 2.1, the third begins with step 3.1.

In step 1.1, the user client sends a request to the BaaS server, the request including the access token. The BaaS server begins to process the exemplary request, but the processing of the request requires that the BaaS server read and/or write user data to the UMS server 47. In order to do this, the BaaS server sends a request to the UMS server in step 1.2, and the request includes the access token (which identifies the user) and a secret key assigned to the BaaS server by the entity that controls the app server. The UMS server checks the access token and the secret key, and if they are valid for the requested operation, performs the operation. In step 1.3, the UMS server responds to the request. The BaaS server completes the request and responds to the user client in step 1.4. Therefore, the UMS server produces and consumes user identity information to and from the BaaS server.

In step 2.1, the user client sends a request to the UMS server, the request including the access token. The UMS server checks the access token, and if it is valid for the requested operation, performs the operation. In step 2.2, the UMS server responds to the request. Therefore, the UMS server produces and consumes user identity information to and from the user client.

In step 3.1, the app server sends a request to the UMS server, the request including a secret key and optionally the access token. The UMS server checks the secret key (and access token if provided), and if they are valid for the requested operation, performs the operation. In step 3.2, the UMS server responds to the request. Therefore, the UMS server produces and consumes user identity information to and from the app server.

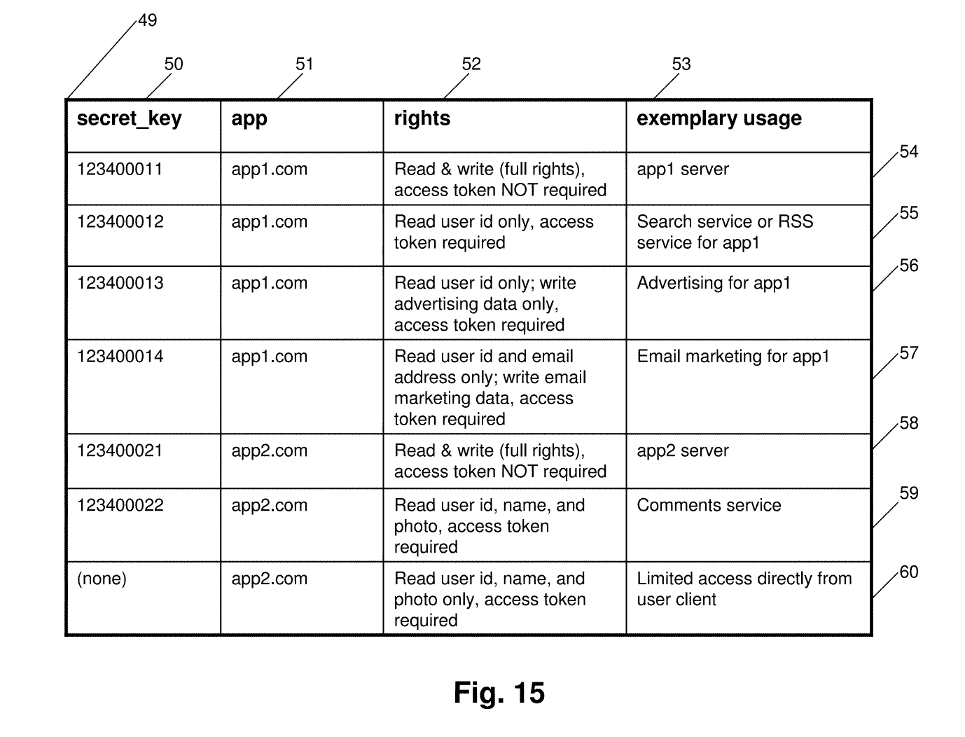

The secret keys used in steps 1.2 and 3.1 of FIG. 14 are controlled by the entity that operates the app server 48. When the entity wishes to enable the BaaS server 46 to perform operations, a secret key is created that is specific to the BaaS server. In the preferred embodiment, a table of secret keys and apps is maintained within the UMS server 47. FIG. 15 is an exemplary table 49 of secret keys and apps. The table has a secret_key column 50, an app column 51, and a rights column 52. The exemplary usage column 53 is for illustrative purposes. The table 49 can be implemented in a number of well-known ways, including for example as a table within a MySQL database. Furthermore, each of the columns within the table can be implemented in a number of well-known ways; in particular, the secret key column 50 may be encrypted and/or indexed, and the column describing the rights 52 may be implemented as multiple columns, as a set of name/value pairs, as an XML or JSON representation, and any other number of well-known methods.

When the UMS server 47 receives a request, the request may include a secret key, an access token, an app identifier corresponding to column 51, additional parameters, or any combination of the foregoing, along with a requested operation. Furthermore, through well-known methods, it is possible for the app identifier to be embedded into the access token and/or the secret key. Exemplary operations include a request to read or write a user's name, write email marketing data, or any number of other operations relating to the UMS server. Upon receipt of the request, the UMS server first searches the table of secret keys and apps against the information included in the request. If the request includes a valid combination of secret key, app, and rights, then the request is performed. If not, the request is not performed. Therefore, the secret key and/or access token are used to grant the BaaS server, the app server, and the user client the ability to read and write user information to and from the UMS server, the user information being specific to the app server corresponding to the given secret key and/or access token. In exemplary table 49, exemplary row 54 describes an entry that will grant full access to app1 to all of the user data in the UMS server that pertains to app1. In exemplary table 49, exemplary row 60 describes an entry that will grant limited access to user clients that can provide an access token relating to app2.

An exemplary use of the foregoing disclosure is an exemplary search service enabled to customize search results and save preferences for each user; an exemplary entry 55 is in the secret key and app table 49. Another exemplary use is an RSS service that can customize an RSS feed and save preferences and settings for each user. Another exemplary use is a payment service that can customize a payment experience based on the identity of a user, utilize user information to check for fraud, and/or save preferences and settings and payment information for each user. Another exemplary use is an analytics service that can utilize user identity information to track users. Another exemplary use is a compliance service that can utilize user identity information and/or user client information to ensure that users read, understand, and agree to legal terms and conditions set forth by an entity that provides the app or website.

It will be understood by one skilled in the art that the present disclosure enables a wide variety and types of services to be implemented within a BaaS server enabled to read and write user data to and from a UMS server. It will also be understood by one skilled in the art that, for convenience, any number of BaaS servers may be implemented within the same computing device. Furthermore, multiple services may be deployed for any one website or app; for example, an exemplary app server intended for selling and marketing transistor radios may be configured to interoperate with a UMS server, a payment service, a content management service, an email marketing service, and an e-commerce service. This configuration enables the exemplary app server to easily integrate compliance, email marketing, e-commerce, payments, and content, for each user of the exemplary app server.

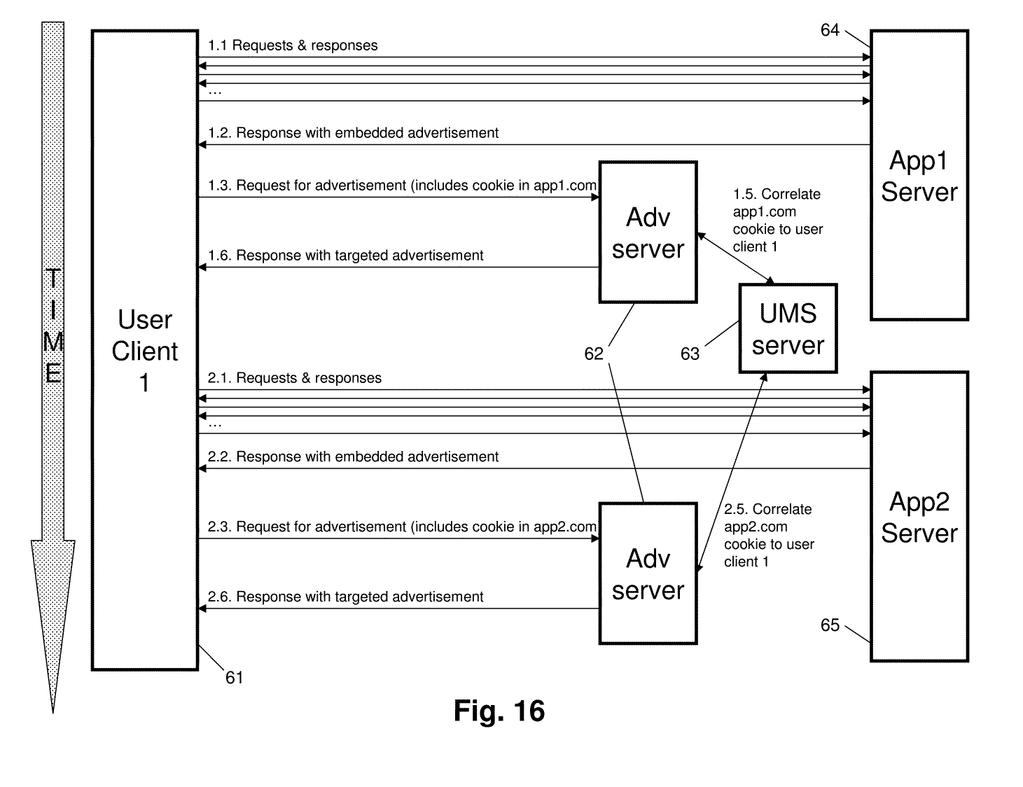

FIG. 16 illustrates an exemplary BaaS server configured as an advertising server 62, a user client 61, a UMS server 63, a first app server 64, and a second app server 65. The exemplary first and second app servers are each owned and controlled by a first and second unrelated entities. Steps 1.1 and 2.1 illustrate the customary requests and responses between the two app servers 64 and 65, and the user client 61. Steps 1.2 and 2.2 illustrate a response from the first and second app servers, each containing an embedded advertisement. The embedded advertisement can be implemented as an HTML <IMG> tag, a client-side script (such as JavaScript), and/or any other method or combination of methods that are well known to a person having skill in the art. The embedded advertisement causes the user client 61 to request an advertisement, as illustrated in steps 1.3 and 2.3, from an advertising server 62. Since the request in step 1.3 arises from step 1.2, which arises from the first app server, then the cookie in step 1.3 from user client 61 is related to a first domain name related to the first app server, and the first domain name is exemplified in FIG. 16 as app1.com. Similarly, since the request in step 2.3 arises from step 2.2, the cookie from the same user client 61 is related to the second app server, and is exemplified in FIG. 16 as app2.com.

In the next step, 1.5 and 2.5, the advertising server 62 sends the contents of the cookies in app1.com and app2.com cookies to the UMS server to request correlation. For example, if the user has signed into the first app server, a first access token will be included the app1.com cookies. If the user has signed into the second app server, a second access token will be included in the app2.com cookies. When the first and second access tokens are provided to the UMS server, the UMS server is able to compare the two access tokens and detect whether the two access tokens correspond to the same user client (and user by implication). There are a number of methods to perform the detection, including utilizing the user identity information (such as name, email address, and other user identifying information). If the two access tokens are determined to be from the same user client, then a targeted advertisement can be selected by the advertising server, and provided back to the user client in steps 1.6 and 2.6.

Although the time dimension in FIG. 16 illustrates that steps 1.1-1.6 would occur before steps 2.1-2.6, it will be clear to a person skilled in the art that steps 2.1-2.6 may occur before steps 1.1-1.6, or nearly simultaneously. FIG. 16 is intended to illustrate and make clear that a single advertising server 62 is capable of correlating one user client utilizing multiple app servers. Therefore, by correlating the user client, the advertising server is able to provide relevant advertisements to a user accessing the second app server, based on knowledge that the user has accessed the first app server.

In an additional embodiment of the advertising server 62, the entities providing the first and second app servers can be individually rewarded for serving advertisements that ultimately result in a sale, even if the user operating user client 61 does not click on any of the advertisements. In the embodiment, the advertising server tracks and correlates the identity of the user, the identity of each advertiser sponsoring each of the advertisements, and the identity of each entity operating each app server. Whenever a sale to a known user of a product or service related to an advertisement occurs, the advertising server is able to correlate the sale to the serving of each related advertisement by a plurality of app servers, and assign a monetary reward to each of the entities operating the plurality of app servers.

For example, a shoe seller chooses to place an advertisement with the advertising server 62. The advertising server places an advertisement related to the shoe seller within eight different websites or apps operated by eight different entities, each operating eight different app servers. The advertising server maintains a record of each placed advertisement. Subsequently, a user operating a user client purchases shoes from the shoe seller; upon doing so, a portion of the sale (a commission) is submitted to the advertising server, along with the identity of the user that purchased the shoes. Using the record of each placed advertisement, the advertising server assigns a portion of the commission to each of the eight different entities. Furthermore, each of the portions may be adjusted based on the number of times the advertisement was shown by each of the eight app servers, by the recency of the advertisements relative to the date the sale is completed, by the type or size of the advertisements, and/or by any other relevant adjustment criteria.

In a variant of the foregoing embodiment, the location of the user client is used by the advertising server to apply a plurality of policies in order to comply with local privacy laws. The determining of the location is implemented using geolocation within mobile devices, by querying a web browser, by determining the closest web server in a CDN network, or by other methods.

In another variant of the foregoing embodiment, the advertising server is configured to track promotional content beyond mere advertisements. For example, it is well known that some blogs and articles and reviews are written with the express purpose of promoting a given seller or product. In this example, the advertising server tracks users that read the blogs and articles and reviews, and includes the entities that provide the content in the sharing of revenue when a relevant sale occurs.

In yet another variant of the foregoing embodiment, in order to protect user privacy, the identity of the user is masked by a hash function. For example, the hash function MD5 can be applied to the user's email address by the shoe seller, prior to submission to the advertising server 62 for assignment of commission. Doing so protects the identity of the user, while still enabling the advertising server to compare MD5-hashed versions of each user email in its database to the submitted hash, and therefore still make the payments described herein.

The user clients, BaaS servers, UMS servers, and app servers, are all computing devices. The global network, including the internet, is a global computer network. Computing devices and global networks are described below.

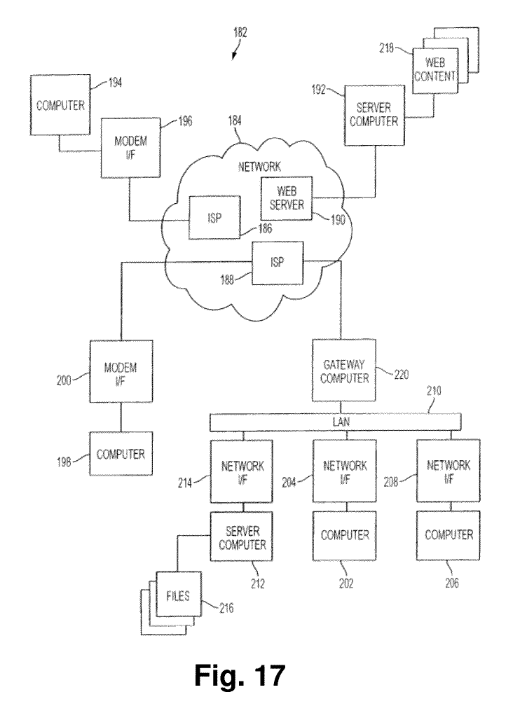

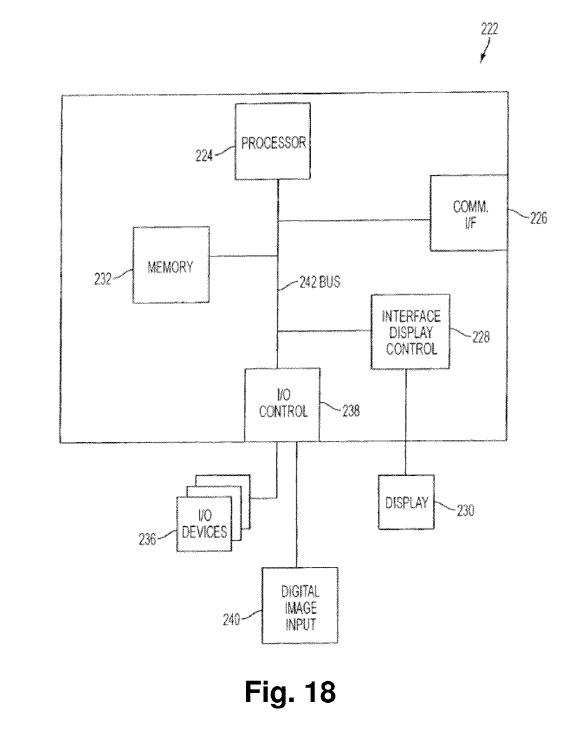

The following description of FIGS. 17 and 18 is intended to provide an overview of computer hardware and other operating components suitable for performing the methods of the invention, but is not intended to limit the many applicable environments as described above. Similarly, the computer hardware and other operating components may be suitable as part of the systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 17 shows several computer systems 182 that are coupled together through a network 184, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 184 is typically provided by Internet service providers (ISP), such as the ISPs 186 and 188. Users on client systems, such as client computer systems 194, 198, 202, and 206 obtain access to the Internet through the Internet service providers, such as ISPs 186 and 188. Access to the Internet allows users of the client computer systems to exchange information, receive and send e-mails, and view documents, such as documents which have been prepared in the HTML format. These documents are often provided by web servers, such as web server 190 which is considered to be “on” the Internet. Often these web servers are provided by the ISPs, such as ISP 186, although a computer system can be set up and connected to the Internet without that system also being an ISP.

The web server 190 is typically at least one computer system which operates as a server computer system and is configured to operate with the protocols of the World Wide Web and is coupled to the Internet. Optionally, the web server 190 can be part of an ISP which provides access to the Internet for client systems. The web server 190 is shown coupled to the server computer system 192 which itself is coupled to web content 218, which can be considered a form of a media database. While two computer systems 190 and 192 are shown in FIG. 17, the web server system 190 and the server computer system 192 can be one computer system having different software components providing the web server functionality and the server functionality provided by the server computer system 192 which will be described further below.

Client computer systems 194, 198, 202, and 206 can each, with the appropriate web browsing software, view HTML pages provided by the web server 190. The ISP 186 provides Internet connectivity to the client computer system 194 through the modem interface 196 which can be considered part of the client computer system 194. The client computer system can be a personal computer system, a network computer, a Web TV system, a wireless PDA or cellular phone or automobile navigation console, or other such computer system.

Similarly, the ISP 188 provides Internet connectivity for client systems 198, 202, and 206, although as shown in FIG. 17, the connections are not the same for these three computer systems. Client computer system 198 is coupled through a modem interface 200 while client computer systems 202 and 206 are part of a LAN. While FIG. 17 shows the interfaces 196 and 200 as generically as a “modem,” each of these interfaces can be an analog modem, ISDN modem, cable modem, satellite transmission interface (e.g. “Direct PC”), urban wireless connectivity (e.g., cellular telephony), peer-to-peer interface (e.g. 802.11 and Bluetooth), or other interfaces for coupling a computer system to other computer systems.

Client computer systems 202 and 206 are coupled to a LAN 210 through network interfaces 204 and 208, which can be Ethernet network or other network interfaces. The LAN 210 is also coupled to a gateway computer system 220 which can provide firewall and other Internet related services for the local area network. This gateway computer system 220 is coupled to the ISP 188 to provide Internet connectivity to the client computer systems 202 and 206. The gateway computer system 220 can be a conventional server computer system. Also, the web server system 190 can be a conventional server computer system.

Alternatively, a server computer system 212 can be directly coupled to the LAN 210 through a network interface 214 to provide files 216 and other services to the clients 202, 206, without the need to connect to the Internet through the gateway system 220.

FIG. 18 shows one example of a conventional computer system 222 that can be used as a client computer system, a server computer system, a web server system, a client portable computer system (e.g. PDA or cellular phone or automobile navigation console), a component of a smart advertising display as previously described, etc. Such a computer system 222 can be used to perform many of the functions of an Internet service provider, such as ISP 186. The computer system 222 interfaces to external systems through the modem or network interface 226. It will be appreciated that the modem or network interface 226 can be considered as the delivery channels 50 (as shown in FIG. 1) and to be part of the computer system 222. This interface 226 can be an analog modem, ISDN modem, cable modem, token ring interface, satellite transmission interface (e.g. “Direct PC”), urban wireless connectivity (e.g., cellular telephony), peer-to-peer interface (e.g., 802.11 and Bluetooth), or other interfaces for coupling a computer system to other computer systems.

The computer system 222 includes a processor 224, which can be a conventional microprocessor such as an Intel® Pentium® microprocessor or Motorola® PowerPC® microprocessor. Memory 232 is coupled to the processor 224 by a bus 242. Memory 232 can be dynamic random access memory (DRAM) and can also include static RAM (SRAM). The bus 242 couples the processor 224 to the memory 232, to display controller 228, and to the input/output (I/O) controller 238.

The interface display controller 228 controls in the conventional manner a display on a display device 230 which can be a cathode ray tube (CRT) or liquid crystal display (LCD). The input/output devices 236 can include a keyboard, disk drives, printers, a scanner, and other input and output devices, including a mouse or other pointing device. The display controller 228 and the I/O controller 238 can be implemented with conventional well known technology. A digital image input device 240 can be a digital camera which is coupled to an I/O controller 238 in order to allow images from the digital camera to be input into the computer system 222.

One of skill in the art will immediately recognize that the terms “machine readable medium” or “computer-readable medium” includes any type of storage device that is accessible by the processor 224 and also encompasses a carrier wave that encodes a data signal.

The computer system 222 is one example of many possible computer systems which have different architectures. For example, personal computers based on an Intel microprocessor often have multiple buses, one of which can be an input/output (I/O) bus for the peripherals and one that directly connects the processor 224 and the memory 232 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 232 for execution by the processor 224. A Web TV system, which is known in the art, is also considered to be a computer system according to the present invention, but it may lack some of the features shown in FIG. 17, such as certain input or output devices. A typical computer system will usually include at least a processor, memory, and a bus coupling the memory to the processor.

In addition, the computer system 222 is controlled by operating system software which includes a file management system, such as a disk operating system, which is part of the operating system software. One example of an operating system software with its associated file management system software is the family of operating systems known as Windows from Microsoft Corporation of Redmond, Wash., and their associated file management systems. Another example of an operating system software with its associated file management system software is the LINUX operating system and its associated file management system. The file management system is typically stored in the memory 232 and causes the processor 224 to execute the various acts required by the operating system to input and output data and to store data in memory.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The systems described in FIGS. 17-18 are therefore capable of enabling the methods described herein regarding the exemplary BaaS server 2, the exemplary user clients 1, and the exemplary app servers 4, 5, and 6, and the features provided to allow users to interface with the system.

While the above description contains many specificities, these should not be construed as limitations on the scope of any embodiment, but as exemplifications of various embodiments thereof. One skilled in the art will appreciate that although specific embodiments of the present system and methods have been described for purposes of illustration, various modifications can be made without deviating from the scope or spirit of the present invention. Many other ramifications and variations are possible within the teachings of the various embodiments. Thus the scope should be determined by the appended claims and their legal equivalents, and not by the examples given.

1. A method of configuring a first computing device connected to a computer network to authenticate a user, said user operating a user client, to two or more app servers connected to said computer network, said method comprising:
receiving a first transmission from said user client through said computer network, said first transmission containing a credential for authenticating said user to a first of the two or more app servers;
determining whether said credential authenticates said user to said first of the two or more app servers; and
sending a second transmission to said user client through said computer network, said second transmission configured to write a cookie containing an access token to said user agent, said cookie being readable by said first of the two or more app servers, and said cookie not being readable by a second of the two or more app servers.

2. the method in claim 1, wherein a domain name system is configured, responsive to a first domain name, to direct the user client to the first of the two or more app servers and the first computing device, and wherein the domain name system is configured, responsive to a second domain name, to direct the user client to the second of the two or more app servers and the first computing device.

3. the method in claim 2, wherein the first transmission includes said first domain name.

4. the method in claim 1, further comprising: receiving a third transmission from said first of the two or more app servers containing at least one of said access token, a secret key, and a resource request.

5. the method in claim 1, wherein the computer network is the internet.

6. the method in claim 1, wherein the user client is instantiated within a second computing device and is one of a web browser, a mobile web browser, and a software program executable by the second computing device.

7. the method in claim 1, wherein the first transmission includes at least one of a password, an email address, a user name, a location, an IP address, a PIN code, a CAPTCHA response, and a browser-identifying information.

8. the method in claim 1, further comprising: receiving a third transmission from a BaaS server containing at least one of said access token, a secret key, and a resource request.

9. the method in claim 8, wherein said BaaS server is an advertising server.

10. the method in claim 1, wherein the determining includes checking pre-configured registration factors, and wherein said factors include at least one of: requiring that the registration originates from a page delivered by the first computing device and not forged by an unauthorized server, requiring that the first transmission occur over an SSL or otherwise encrypted connection, requiring a correct answer to a CAPTCHA or similar challenge, performing a unique browser identifier check, checking that the user reads and accepts one or more legal agreements associated with the first app server, checking if the user is already registered with the first app server, checking that a submitted user email address is valid, checking a reputation of an IP address associated with the user client, checking if a submitted user name is valid or includes unacceptable words such as known trademarks, checking if the first app server is allowing registrations at the time that said factors are checked, flagging a given registration as requiring further approval by the first app server, checking for one or more required parameters (such as first name, last name, username, email, birthday, ZIP code, or other desired combinations), checking if an age of the user meets certain criteria, checking if a location of the user meets certain criteria, checking if a user agent related to the user client is acceptable, checking if the user (based on an IP address, a session ID, or other indicia) has created too many accounts in a given period of time, checking if a submitted email address is capable of receiving emails, checking if a submitted email address resolves to a blacklist of known spammers, and checking if an entity that owns the first app server has paid all due fees to the entity that operates the first computing device.

11. the method in claim 1, wherein the determining includes checking pre-configured sign-in factors, and wherein said factors include at least one of: checking a reputation of a user session associated with the user client, checking an IP address associated with the user client, requiring that the first transmission originates from a page delivered by the first computing device and not from a forged server, requiring that the first transmission occur over an SSL or otherwise encrypted connection, checking a user agent identifier associated with the user client, checking an OS version identifier associated with the user client, checking a browser software vendor and version associated with the user client, checking an accept-language field associated with the user client, checking a screen resolution field associated with the user client, performing a unique browser identifier check, checking an ETAG associated with a user avatar, checking a result of a CAPTCHA challenge, checking if the first app server is accepting logins, checking if an account associated with the user has been disabled or blocked, checking if an account associated with the user is in good billing standing, checking if an account associated with the first app server is in good billing standing, checking if a portion of the credentials have been used too many times within a period of time, checking if the user has provided all required information, and checking that the user reads and accepts one or more legal agreements associated with the first app server.

12. A UMS server comprising:
an interface for receiving a first transmission from a user client, said first transmission containing a credential for authenticating a user to a first of two or more app servers, said interface connected to a computer network, said first of two or more app servers connected to said computer network, and a second of two or more app servers connected to said computer network;
a processor for determining whether said credential authenticates said user to said first of the two or more app servers, and for preparing a second transmission for sending through said interface to said user client, said second transmission configured to write a cookie containing an access token to said user agent, said cookie being readable by said first of the two or more app servers, and said cookie not being readable by said second of the two or more app servers.

13. A UMS server as recited in claim 12, wherein a domain name system is configured, responsive to a first domain name, to direct the user client to the first of the two or more app servers and the UMS server, and wherein the domain name system is configured, responsive to a second domain name, to direct the user client to the second of the two or more app servers and the UMS server.

14. A UMS server as recited in claim 13, wherein the first transmission includes said first domain name.

15. A UMS server as recited in claim 12, wherein said interface is configured to receive a third transmission from said first of the two or more app servers, and said third transmission contains at least one of said access token, a secret key, and a resource request.

16. A UMS server as recited in claim 12, wherein the first transmission includes at least one of a password, an email address, a user name, a location, an IP address, a PIN code, a CAPTCHA response, and a browser-identifying information.

17. A UMS server as recited in claim 12, wherein said interface is configured to receive a third transmission from a BaaS server containing at least one of said access token, a secret key, and a resource request.

18. A UMS server as recited in claim 17, wherein said BaaS server is an advertising server.

19. A UMS server as recited in claim 12, wherein the processor is configured to check pre-configured registration factors, and wherein said factors include at least one of: requiring that the registration originates from a page delivered by the UMS server and not forged by an unauthorized server, requiring that the first transmission occur over an SSL or otherwise encrypted connection, requiring a correct answer to a CAPTCHA or similar challenge, performing a unique browser identifier check, checking that the user reads and accepts one or more legal agreements associated with the first app server, checking if the user is already registered with the first app server, checking that a submitted user email address is valid, checking a reputation of an IP address associated with the user client, checking if a submitted user name is valid or includes unacceptable words such as known trademarks, checking if the first app server is allowing registrations at the time that said factors are checked, flagging a given registration as requiring further approval by the first app server, checking for one or more required parameters (such as first name, last name, username, email, birthday, ZIP code, or other desired combinations), checking if an age of the user meets certain criteria, checking if a location of the user meets certain criteria, checking if a user agent related to the user client is acceptable, checking if the user (based on an IP address, a session ID, or other indicia) has created too many accounts in a given period of time, checking if a submitted email address is capable of receiving emails, checking if a submitted email address resolves to a blacklist of known spammers, and checking if an entity that owns the first app server has paid all due fees to the entity that operates the UMS server.

20. A UMS server as recited in claim 12, wherein the processor is configured to check pre-configured sign-in factors, and wherein said factors include at least one of: checking a reputation of a user session associated with the user client, checking an IP address associated with the user client, requiring that the first transmission originates from a page delivered by the UMS server and not from a forged server, requiring that the first transmission occur over an SSL or otherwise encrypted connection, checking a user agent identifier associated with the user client, checking an OS version identifier associated with the user client, checking a browser software vendor and version associated with the user client, checking an accept-language field associated with the user client, checking a screen resolution field associated with the user client, performing a unique browser identifier check, checking an ETAG associated with a user avatar, checking a result of a CAPTCHA challenge, checking if the first app server is accepting logins, checking if an account associated with the user has been disabled or blocked, checking if an account associated with the user is in good billing standing, checking if an account associated with the first app server is in good billing standing, checking if a portion of the credentials have been used too many times within a period of time, checking if the user has provided all required information, and checking that the user reads and accepts one or more legal agreements associated with the first app server.
